(19) United States
(12) Patent Application Publication
(10) Pub. No.: US 2014/0305742 A1
(43) Pub. Date: Oct. 16, 2014

(54) ELEVATOR

(71) Applicant: GEDA-Dechentreiter GmbH & Co. KG, Asbach-Baumenheim (DE)

(72) Inventor: Ulrich Graf, Donauworth (DE)

(73) Assignee: GEDA-Dechentreiter GmbH & Co. KG, Asbach-Baumenheim (DE)

(21) Appl. No.: 14/248,807

(22) Filed: Apr. 9, 2014

(30) Foreign Application Priority Data
Apr. 10, 2013 (DE) 10 2013 006 146.6

(51) Int. Cl. B66B 9/187

(52) U.S. Cl. CPC B66B 9/187
USPC 187/239

(57) ABSTRACT

A lift having a guideway, a ground station, a lift car guided on the guideway, a cable running along the guideway to the lift car, which is passed via a cable trolley with a pulley fixture which follows a movement of the lift car, and a central infeed into which the cable can be fixed and which can be fixed to the guideway, wherein a storage facility is provided both at the ground station and on the lift car allowing for an extension of the section of cable running between the central infeed and the ground station for raising the central infeed to be supplied from the storage facility at the ground station, and an extension of the section of cable running via the cable trolley, necessary due to the extension of the guideway to be supplied from the storage facility.

### BACKGROUND OF THE INVENTION

1. Field of the Invention

The invention relates to a lift, in particular an external lift.

2. Description of Related Art

External lifts are, for example, used on building sites to transport persons and material to the upper floors of the building being built or renovated.

Such external lifts generally feature a guideway which is fixed to a wall of the building and extends in a vertical direction. The guideway consists of one or two mast towers to which a lift car is attached in such a way that it can travel. The lift car carries the persons or goods which are to be transported.

The mast towers thus serve to guide the movement of the lift car, whereby these may also represent a part of the drive train. As a rule, at least one of the mast towers is provided with at least one rack which extends in a longitudinal axial direction of the guideway and with which a pinion of an electrical lift drive engages. In such lifts, the lift drive is thus housed in the region of the lift car and is, accordingly, moved along with the lift car.

Because of the not inconsiderable power of the lift drive of such lifts, these are supplied with electrical energy by means of a cable. In the case of a lift drive which is carried with the lift car, the cable must therefore be of sufficient length in order to permit the lift car to be moved to its highest position on the guideway. However, many lifts reach heights on the guideway of up to several hundred meters, which imposes demanding requirements in terms of the storage and guidance of the cable. In particular, the cable must be stored safely in the vicinity of a ground station of the lift when the lift car is located in a position relatively low down on the guideway. In some cases, several hundred meters of cable must be stored in a space-saving manner in such a way that it is possible to lengthen or shorten the section of cable connecting the ground station with the lift car without any problem. It must be possible to perform such lengthening and shortening over numerous cycles without damaging the cable and without the cable becoming caught up or tangled. Moreover, an uncontrolled movement of the cable, particularly in the region of the ground station of the lift, should be prevented. In many cases, the cables are simply stored in more or less the same form in a round cable container which is open at the top, also known as a cable tray.

It is also known, in particular in the case of lifts with a relatively high guideway, for so-called cable trolleys to be used which are also guided on the guideway and which possess a pulley over which the cable is guided. The section of the cable coming from the ground station is fixed in a so-called central infeed at around half the height of the guideway. The section between the central feed and the lift car has a length which makes it possible for the lift car to reach the highest and lowest stopping positions on the guideway. The surplus section of the cable, depending on the distance between the fixing point and the lift car, is passed in a loop over the pulley fixture of the cable trolley. The cable trolley is also guided on the guideway of the lift, always being positioned below the lift car and following its movement at half the speed. The cable trolley is thereby positioned in the vicinity of the lift car when this is located in the ground station and at around half the height of the guideway when the lift car has reached its highest position on the guideway.

The erection of such a lift is a complex matter. As a rule, starting out from a ground station the guideway is successively extended through the attachment of individual guideway segments, whereby the guideway segments are transported in the lift car to the upper end of the section of guideway which has already been erected and fitted to this end from the lift car.

One problem which arises with such a method of erection involves the guidance of the cable during erection. The cable has to follow the up-and-down movement of the lift car, whereby as a result of the successive extension of the guideway this movement takes place over increasing distances. It is known for the length of cable which is not required to be stored in the vicinity of the ground station, which, however, involves a continual spooling and unspooling or coiling and uncoiling of the cable. This increases the wear on the cable.

In lifts equipped with cable trolleys, this disadvantage can be reduced through early use of the cable trolley. However, this requires a continual repositioning of the central infeed to follow the extension of the guideway. However, since the distances travelled by the lift car also increase at the same time, it is necessary at regular intervals to detach the cable fixed in the central infeed, extend it from the storage location at the ground station and fix it to the central infeed again in a new position. This involves considerable effort.

In order to avoid this it is known for the drive of the lift car to be supplied, at least during one section of the erection process, via a so-called erection cable which is not passed via the cable trolley and which is suitable, in terms of construction and design, for the strain resulting from the repeated spooling and unspooling or coiling and uncoiling.

### SUMMARY OF THE INVENTION

Starting out from this prior art, the invention was based on the problem of designing a lift which is improved, in particular with respect to its erectability.

This problem is solved through a lift according to the description herein and the claims. Additionally, a method for erecting such a lift is the subject matter of additional claims. Advantageous embodiments of the lift according to the invention as well as of the method according to the invention are the subject matter of the relevant claims and are explained in the following description of the invention.

The above and other objects, which will be apparent to those skilled in the art, are achieved in the present invention which is directed to a lift having a guideway, a ground station, a lift car guided on the guideway, a cable running along the guideway to the lift car, which is passed via a cable trolley with a pulley fixture which follows a movement of the lift car, and a central infeed into which the cable can be fixed and which can be fixed to the guideway, wherein a storage facility for storage of a section of cable is provided both at the ground station and on the lift car.

The storage facility at the ground stationor on the lift car, or both, stores the relevant section of cable in figures of eight or in coils, and may store the relevant section of cable in offset figures of eight.

The storage facility may be arranged on the roof of the lift car.

The central infeed may include a fastener for receiving a lifting element.

The lift may further include a cable holder arranged on the lift car into which the cable can be fixed. The cable may be fixed in the cable holder by a clamping device which is self-reinforcing in interaction with the weight of the section of cable running via the cable trolley.

The cable may also be fixed in the cable holder by a spring-loaded clamping device.

The lift may include a hoisting device into which the cable is fixed and which is movable along the guideway. The cable is fixed in the hoisting device by a clamping device which is self-reinforcing in interaction with the weight of the section of cable running along the guideway.

The cable may be introduced laterally into the cable trolley.

The cable trolley may include a pulley element which is arranged between two side components, one of said side components being removable from the pulley element in order to permit lateral introduction of the cable.

The lift may further include a cable guide fixed to the guideway below the central infeed in which the cable is guided. The cable guide may include a guide region for the section of cable extending between the ground station and the central infeed as well as one or two separate guide regions for the section of cable passed via the cable trolley.

In a second aspect, the present invention is directed to a method for erecting a lift according to design disclosed herein, wherein the guideway extends to a total length through the addition of individual guideway segments, wherein the central infeed is fixed to the guideway at different heights, following the extension of the guideway, such that an extension of the section of cable running between the central infeed and the ground station which is necessary in order to raise the central infeed is supplied from the storage facility at the ground station and an extension of the section of cable running via the cable trolley which is necessary due to the extension of the guideway is supplied from the storage facility of the lift car.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1a shows a perspective view of the upper part of a lift according to the invention;

FIG. 1b shows a perspective view of the lower part of the lift;

FIG. 2a shows a frontal view of the upper part of the lift;

FIG. 2b shows a frontal view of view the lower part of the lift;

FIG. 3 shows a perspective view of the lift car of the lift with storage facility;

FIG. 4 shows a perspective view of the storage facility at the ground station of the lift;

FIG. 5 shows a perspective view of the central infeed and a cable guide of the lift;

FIG. 6 shows a perspective view of the opened cable trolley of the lift;

FIG. 7 shows a perspective view of the cable holder of the lift;

FIG. 8 shows a frontal view of the cable holder of the lift;

FIG. 9 shows a perspective view of the hoisting device of the lift;

FIG. 10 shows a diagrammatic representation of the guidance and storage of the cable during erection of the lift;

FIG. 11 shows a first alternative embodiment the central infeed; and

FIG. 12 shows a second alternative embodiment of the central infeed.

### DESCRIPTION OF THE PREFERRED EMBODIMENT(S)

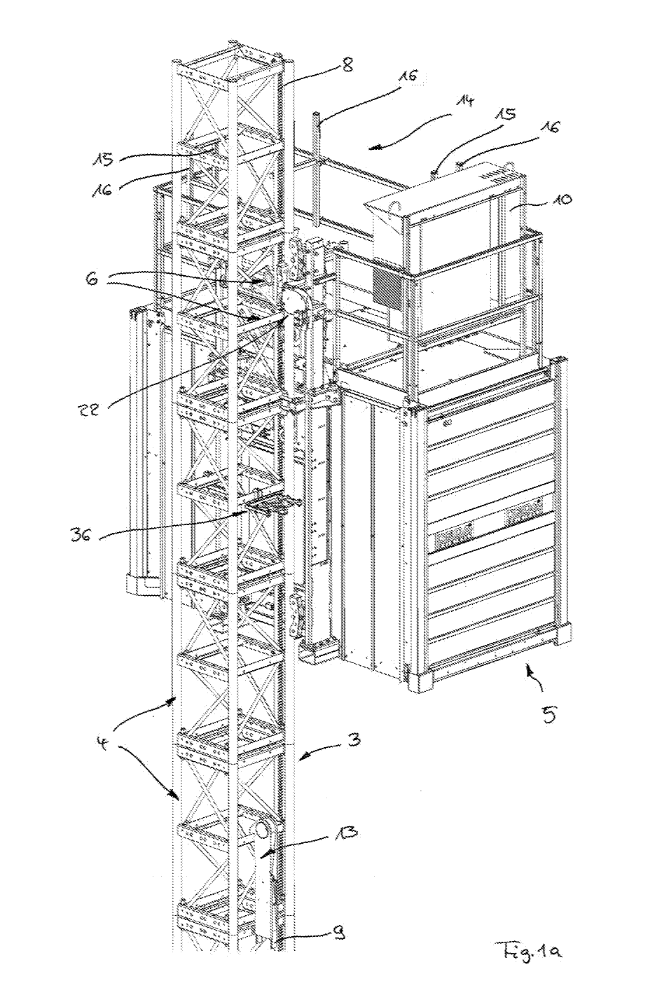

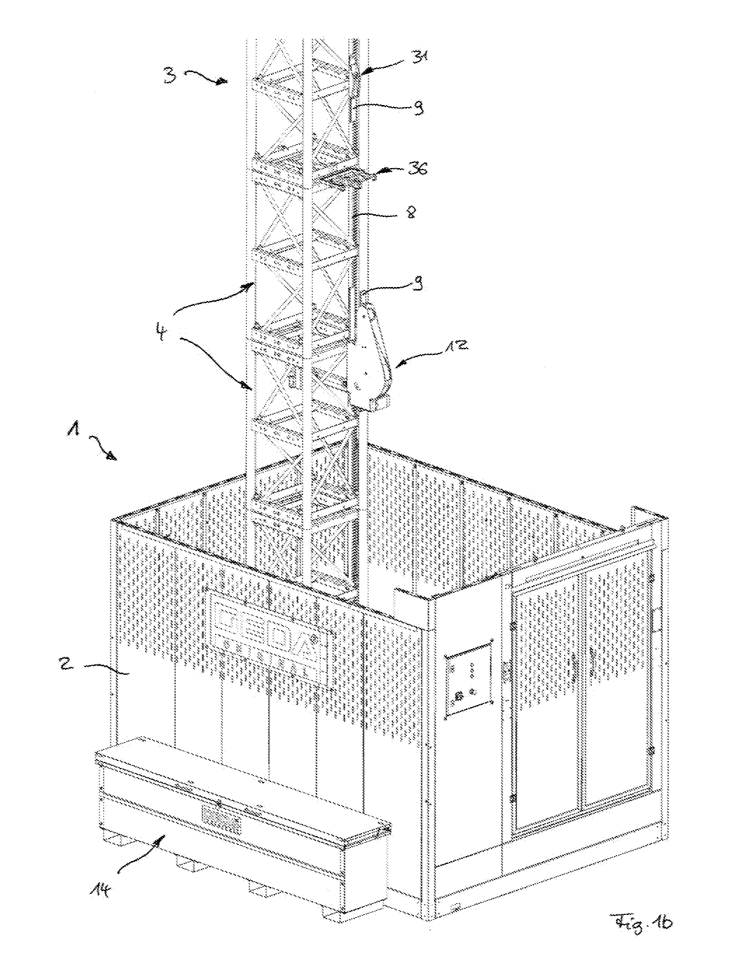

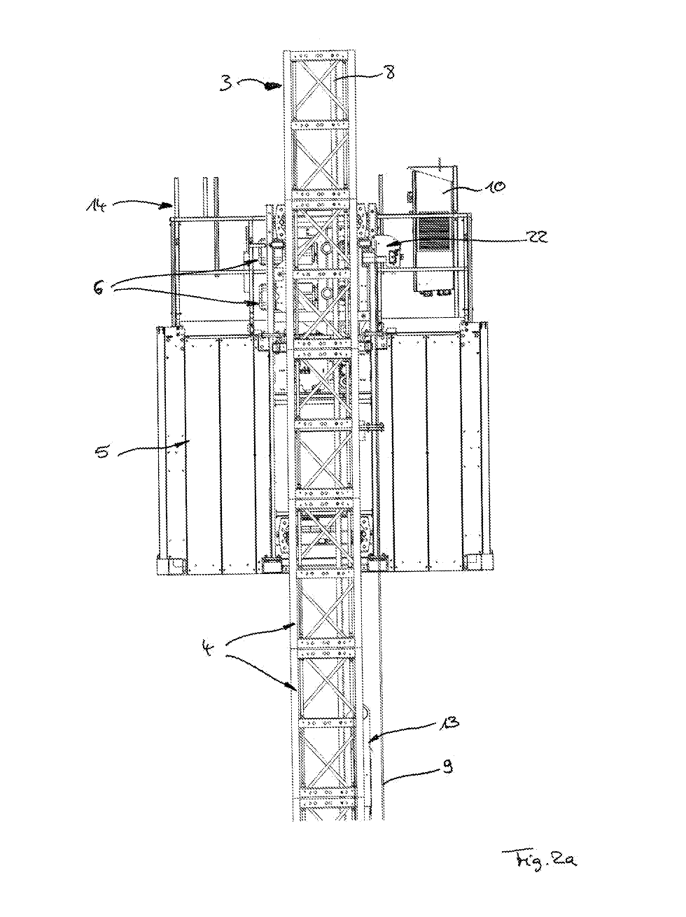

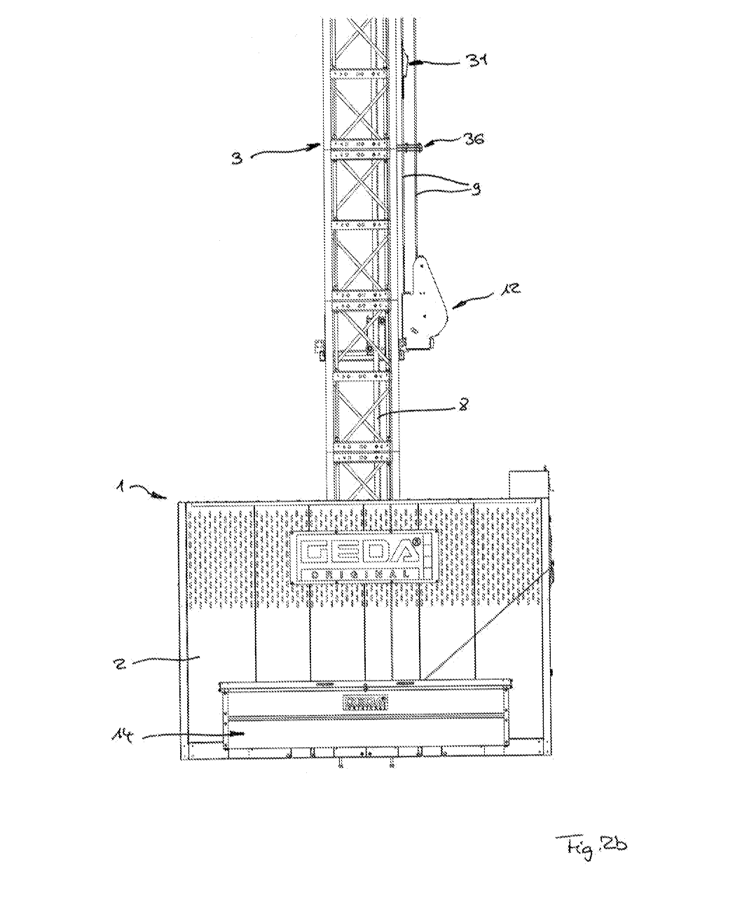

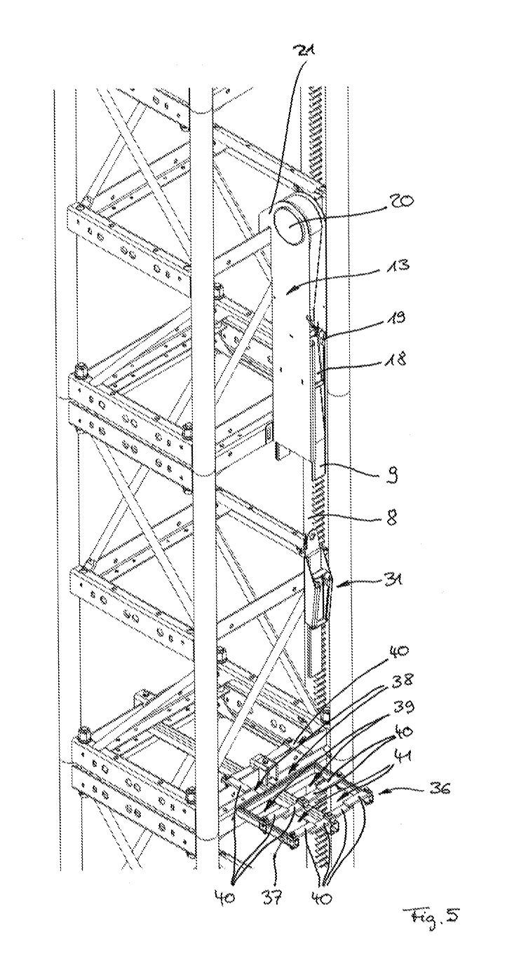

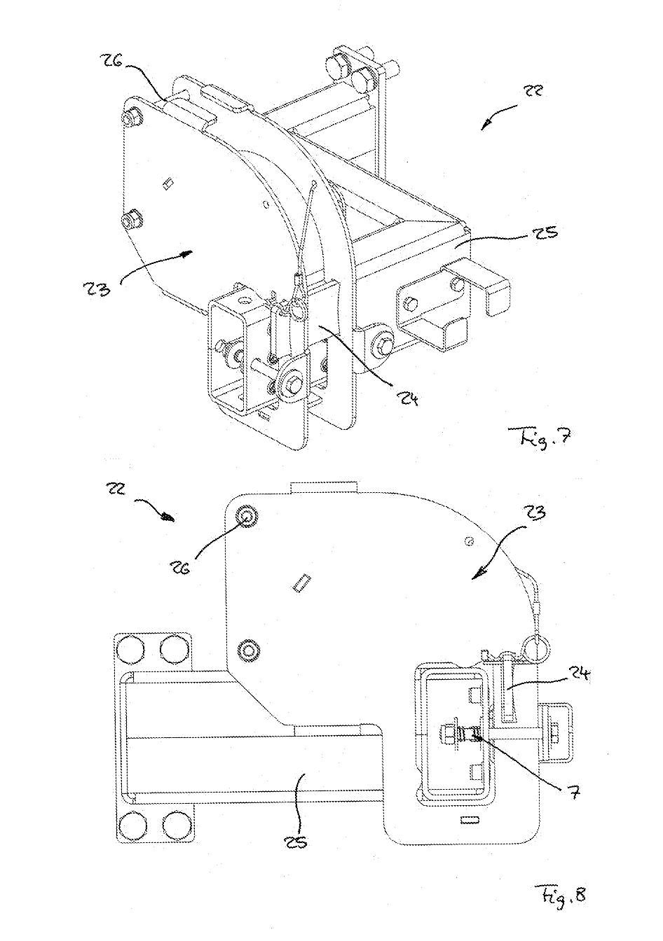

In describing the preferred embodiment of the present invention, reference will be made herein to FIGS. 1-12 of the drawings in which like numerals refer to like features of the invention.

A lift of the generic type comprising a guideway, a ground station, a lift car guided on the guideway, a cable running along the guideway to the lift car, in particular a flat cable which runs via a cable trolley equipped with a pulley fixture which follows the movement of the lift car, and a central infeed which serves to clamp the cable in position and which can be fixed to the guideway, is further developed according to the invention in that a storage facility for the storage of a section of the cable is provided both at the ground station and on the lift car.

Such a lift makes it possible to erect the lift according to a method in which the guideway is successively extended to a total length through the addition of individual guideway segments, wherein the central infeed is fixed to the guideway at different heights, following the extension of the guideway. According to the invention, an extension of the section of cable running between the central infeed and the ground station which is necessary in order to increase the height of the central infeed is supplied from the storage facility at the ground station and an extension of the section of cable running via the cable trolley which is necessary due to the extension of the guideway is supplied from the storage facility on the lift car.

The embodiment of a lift according to the invention allows sections of the cable (which are preferably of substantially the same length) to be stored both in the vicinity of the ground station and on the lift car during erection. The central infeed can also already be fixed to the point on the cable at which it is also required to fix the cable in place when in operation at the start of the erection process. In order to simplify this, the cable can preferably be provided (e.g. printed) with a length scale. The extension of the section of cable running between the ground station and the central infeed which is necessary due to the repositioning of the central infeed can be achieved by supplying cable from the storage facility in the vicinity of the ground station. In contrast, the extension of the section of cable running via the cable trolley, and thus running between the lift car and the central infeed, which is intended to make it possible to extend the travel distance of the lift car successively during the course of erection, can be realized by supplying cable from the storage facility on the lift car. Thus, a lift of the generic type can be erected without the cable needing to be spooled and unpooled or coiled and uncoiled in the vicinity of the ground station with each up-and-down movement of the lift car and without a continual supply of additional cable to the central infeed being necessary. The effort involved in the erection of the lift is thus comparatively small.

The lift according to the invention can be dismantled in a corresponding manner. The increasingly shortened section of cable between the central infeed and the ground station can be stored in the storage facility at the ground station, while the increasingly shorter length of the section of cable running via the cable trolley which is necessary in order to allow the lift car to move is compensated through storage in the storage facility on the lift car.

An advantageous possibility for storing the sections of cable in the storage facility at the ground station and/or on the lift car can involve layering these in the form of figure-of-eight loops (“figures of eight”) or simple coils. This can represent a storage possibility which saves space and protects the cable. Key advantages of this form of storage are, on the one hand, the relatively long length of cable section which can be stored in the individual layers and on the other hand the advantageous handling when uncoiling the cable during the erection of the lift. Storage in figures of eight is practical, in particular, where a round cable is used (cable with a round, in particular circular cross section) in order to prevent the cable from becoming twisted when uncoiling. Where a flat cable is, preferably, used, in addition to storage in figures of eight the cable can also be stored in simple coils, i.e. always with the same direction of coiling (in the turns), since flat cables do not tend to twist and the alternating direction of coiling (in the turns) occurring with storage in figures of eight is not necessary.

In order to make possible a simple and stable storage in figures of eight or coils, in particular flat, i.e. horizontally arranged figures of eight or coils, the storage facilities can possess storage rods around which the corresponding section of cable is laid in order to form the individual figure of eight or coil layers. For example, (at least) two storage rods can be provided for storage in “straight” figures of eight or in coils.

A particularly effective utilization of the storage surface available in the storage facility can be achieved in that the storage facility at the ground station and/or on the lift car stores the relevant section of cable in figures of eight or coils which are arranged offset at an angle (at their points of intersection). For this purpose, the storage facility can for example possess (at least) three storage rods which are not arranged in a straight line.

In a preferred embodiment of the lift according to the invention, the storage facility on the lift car can be provided on its roof. This allows advantageous use to be made of the surface area available. In addition, in contrast to storage on one or more side walls of the lift car, which is also fundamentally possible, such an arrangement of the storage facility has the advantage that the storage facility does not increase the base surface area of the lift car. This means that this cannot, for example, collide with a security fence around the ground station.

In particular in the case of a storage facility arranged on the roof of the lift car, the corresponding section of cable can, advantageously, be stored in offset figures of eight.

In order to facilitate the repeated raising of the central infeed during the erection of the lift according to the invention, the central infeed can be provided with attachment means, for example, a lug, designed to receive a lifting element (e.g. a hook). The raising of the central infeed, which due to the central infeed being fixed to a point on the cable involves a supply of additional cable from the storage facility at the ground station, can thus be achieved in a simple manner, by means of, for example, a crane (this should be understood to mean any form of cable winch) or also by means of the lift car itself.

The central infeed can be raised with each attachment of a guideway segment. This allows the arrangement of a cable guide above the central infeed to be dispensed with. This can then make it possible, advantageously, to reposition the central infeed by means of the lift car.

In a further preferred embodiment of the lift according to the invention a cable holder, arranged on the lift car or moving together with this, into which the cable can be fixed, is provided. If the cable is fixed therein, the cable holder can primarily act as strain relief for the connection of the cable to the drive arranged on the lift car. The cable holder can thus prevent the weight of the section of cable running via the cable trolley as well as the weight of the cable trolley from acting on the connection, designed for example in the form of a plugged connection. In addition, the cable holder can guide the cable in such a way that this runs at a sufficient distance from the lift car. This can prevent the cable from coming into contact with the lift car during operation.

The detachable nature of the fixing of the cable in the cable holder makes it possible to ensure that cable can be dispensed from the storage facility arranged on the lift car during the erection of the lift according to the invention.

In a preferred embodiment of the cable holder, this can possess a clamping device for fixing the cable. This can in particular be designed such that the clamping effect, in interaction with the weight of the section of cable running via the cable trolley, is self-reinforcing. Alternatively or additionally, the clamping device can be spring-loaded (in its clamping position).

In a further preferred embodiment of the lift according to the invention, a hoisting device can be provided into which the cable can be fixed and which possesses means for moving (the hoisting device) along, or fixing to, the guideway. The hoisting device can then be used, in particular, if the central infeed was not fixed to the correct, i.e. final position on the cable at the start of the erection process and the central infeed therefore needs to be fixed to a different position on the cable during erection. The central infeed can then be, or remain, fixed to the guideway and the cable drawn up by means of the hoisting device, i.e. drawn from the storage facility at the ground station, without the central infeed being moved. It is also possible to fix the cable to the guideway by means of the hoisting device and reposition the central infeed, detached from the cable, to the desired position on the cable.

The means for moving the hoisting device can, in particular, be in the form of attachment means, for example in the form of a lug, designed to receive a lifting element (e.g. a hook). Thus extension of the cable can thus be achieved in a simple manner, e.g. by means of a crane.

Preferably, the hoisting device can possess a clamping device for the cable which is self-reinforcing in interaction with the weight of the section of cable running along the guideway.

In a further preferred embodiment of the lift according to the invention, the cable trolley can be so designed that the cable can be introduced into this laterally. This allows subsequent installation of the cable trolley, without a free end of the cable needing to be available. For this purpose the cable trolley can possess a pulley element, in particular a deflecting pulley, which is arranged between two side components, wherein one side component can be removed, for example hinged away from, the pulley element, in order to allow the cable to be introduced from the side.

Preferably, the lift according to the invention lift can possess one or more cable guides, arranged at different heights, which are (also) fixed to the guideway below the central infeed, in which the section of cable extending between the ground station and the central infeed is guided. Advantageously, the cable guides are so designed that these do not fix the cable in place (but only limit its lateral freedom of movement) in order to allow the supply of additional cable during erection.

Preferably, the cable guide can possess a guide region for the section of cable extending between the ground station and the central infeed as well as one or two guide regions, separate from this, for the section of cable running via the cable trolley. The separation of the individual sections of cable allows any contact between these to be prevented as far as possible.

The subject matters of the claims represent advantageous embodiments for lifts designed according to the invention in particular, but are also suitable for the improvement of any lifts of the generic type.

In order to provide a better overview, the cable of the lift is not shown, or only shown in sections, in the drawings.

The lift shown in the drawings comprises a ground station 1 with a security fence 2, from which a guideway 3 extends in a vertical direction. The guideway 3 consists of individual guideway segments 4 which are connected together. The guideway segments 4 are structured as a lattice framework of connected struts, wherein four (alternatively: two) parallel vertical struts are provided which are connected together by means of a plurality of cross-struts. The cross section of the guideway 3 is rectangular; the vertical struts have a circular cross section.

A lift car 5 is guided movably on one of the sides of the guideway 3. For this purpose, several roller guides are provided which roll on two adjacent vertical struts of the guideway 3 which serve as guide rails.

The lift car 5 also includes a traction drive with several electric motors 6, the drive pinions of which engage in a gear rack 8 which runs parallel to the vertical struts of the guideway 3. The lift car 5 can be moved along the guideway 3 through operation of the electric motors 6.

The electric motors 6 are supplied with electrical energy via a (flat) cable 9. A section of cable extends between a switchbox 10 arranged on the roof of the lift car 5 and a pulley fixture 11 of a cable trolley 12 as well as between the pulley fixture 11 and a central infeed 13, which following complete erection of the lift is fixed to the guideway 3 at around half its height. Starting out from the central infeed 13, a further section of cable runs along the guideway 3 to the ground station 1, where it is connected to an electrical energy source.

In addition to the pulley fixture lithe cable trolley 12 also possesses a guide fixture 17 which passes via the pulley fixture 11 to the guideway 3. In the event of a movement of the lift car 5, the cable trolley 12 moves in the same direction, but—due to the single deflection—at only half the speed.

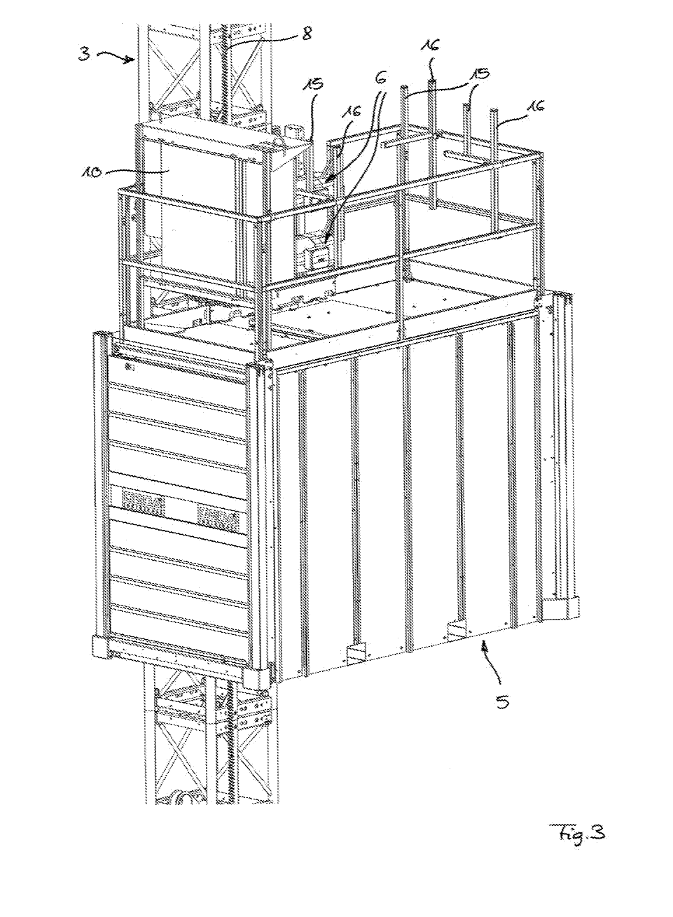

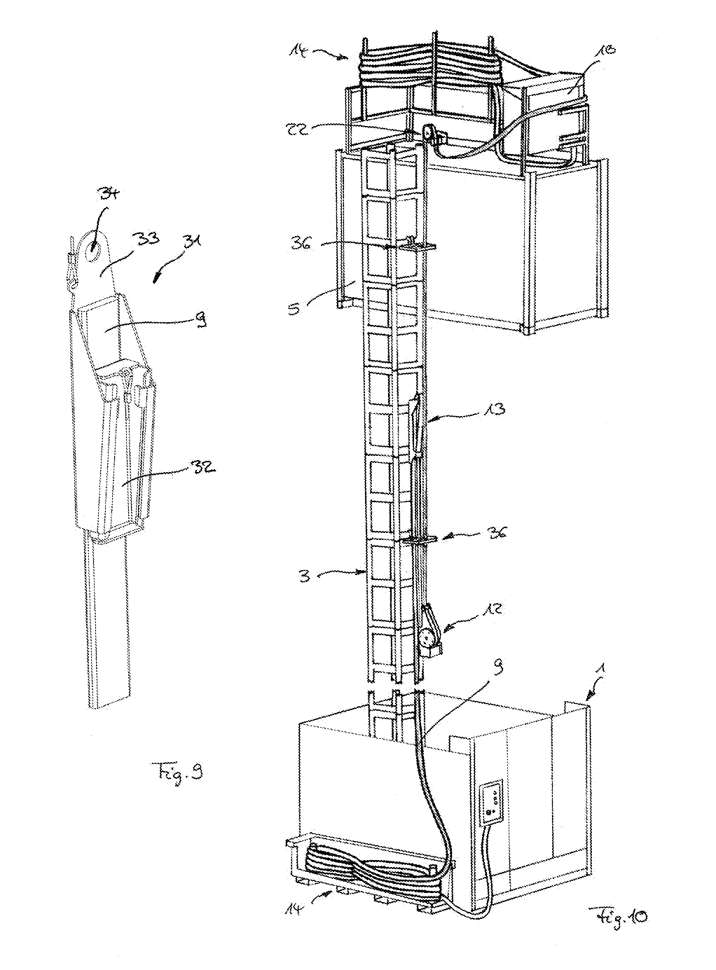

A storage facility 14 for the storage of a section of cable, in particular during the erection and dismantling of the lift, is provided in the vicinity of the ground station 1. The storage facility 14 comprises a housing with a cover which opens. Two storage rods 15 are provided within the housing, in the vicinity of the longitudinal ends (see FIG. 4). The section of cable which is to be stored is laid around these in several layers, each of which forms a figure of eight (see FIG. 10).

A storage facility 14 is also provided on the roof of the lift car 5 in which a section of cable can be stored, in particular during the erection and dismantling of the lift. The corresponding section of cable is thereby laid around a total of three storage rods 15 in several layers, each of which forms an offset figure of eight, as shown diagrammatically in FIG. 10. Two or three retaining rods 16, which are arranged adjacent to the three storage rods 15, are intended to prevent the cable 9 from slipping down over the edge of the lift car 5.

The lift is erected in that individual guideway segments 4 are successively fitted to the upper, free end of the already existing guideway 3 and fixed to this. As from a certain height of the guideway 3, this is done from the lift car 5, which already runs on the existing guideway 3, in particular from the roof of the lift car 5. A few guideway segments 4 can be stored within the lift car 5 and drawn onto the roof via an opening in the roof (e.g. by means of a cable winch). However, once these guideway segments 4 have been installed, the lift car 5 must be moved to the ground station 1 in order to pick up new guideway segments 4. The lift car 5 can then be moved back to the upper end of the guideway 3.

According to the invention, at the start of the erection process the central infeed 13 is fixed to the cable 9 at that point on the cable 9 at which this is also positioned during final operation of the lift, i.e. after the guideway 3 has reached its full height. As can be seen in FIG. 5 in particular, for this purpose the central infeed 13 possesses a clamping plate 18, which runs in a guideway 19 obliquely in relation to a clamping surface. The cable 9 is passed between the clamping plate 18 and the clamping surface, clamping it in place. The inclination of the clamping plate 18 is chosen such that an increasing weight of the section of cable running from the central infeed 13 to the ground station 1 leads to an increase in the clamping pressure. In addition, the central infeed 13 forms a tubular pulley fixture 20 over which the cable 9 is deflected. An attachment device 21 is provided by means of which the central infeed 13 can be fixed in different positions on the guideway 3. The attachment device 21 can, in particular, be designed as a simple hook, so that the fixing to the guideway 3 takes place through hooking in place.

At the start of the erection process, the majority of the lower section of cable (starting out from the central infeed 13) is stored in the storage facility 14 at the ground station 1 and the majority of the upper section of cable is stored in the storage facility 14 on the lift car 5. During erection, the central infeed 13 is moved higher at regular intervals, following the increasing extension of the guideway 3. This leads to an extension of the lower section of cable, which is made possible by supplying additional cable 9 from the storage facility 14 at the ground station 1. However, as the height of the guideway 3 increases, the distance which the lift car 5 regularly has to travel between the ground station 1 and the upper end of the guideway 3 also increases. In order to make this possible, cable 9 is successively dispensed from the storage facility 14 on the lift car 5, following the extension of the guideway 3. Following complete erection of the lift, depending on the length of the cable 9 used, a further relevant length of the cable 9 can be retained in one or both storage facilities 14, or the relevant section of cable will have been completely removed from the storage facilities.

Since the central infeed 13 is loaded at least with the weight of the section of cable which extends between this and the ground station 1, as from a certain height a manual repositioning of the central infeed 13 is no longer possible. Instead, the central infeed 13 needs to be repositioned by means of a crane (not shown) or the lift car 5 itself. For this purpose, a crane hook or connecting means of the lift car 5 can engage in the aperture formed by the tubular pulley fixture 20, so repositioning the central infeed 13.

In the region of the lift car 5, the cable 9 is passed via a cable holder 22 connected with the lift car 5. This comprises a pulley fixture 23, in which a clamping device is integrated. The cable 9 can be fixed in place by means of the clamping device. The cable holder 22 primarily serves as strain relief for the connection of the cable 9 to the switchbox 10. The weight of the section of cable running between the cable holder 22 and the central infeed 13 as well as that of the cable trolley 12 is supported by the cable holder 22. This means that the connection of the cable 9 to the switchbox 10, preferably designed as a plugged connection, is largely unloaded.

The clamping device of the cable holder 22 is effected by a clamping plate 24 of the pulley fixture 23 in interaction with a clamping surface of a supporting structure 25 of the cable holder 22. The cable 9 is passed between the clamping plate 24 and the clamping surface, whereby the clamping of the cable 9 is effected through the pulley fixture 23 being mounted on the supporting structure 25 with a limited freedom of rotation. The mounting of the pulley fixture 23 on the supporting structure 25 is thereby so chosen that the tension caused by gravity which is exercised on the pulley fixture 23 of the cable holder 22 by the section of cable running via the cable trolley 12 causes the clamping plate 24 to approach the clamping surface and thus leads to a self-reinforcing clamping effect. In addition, a spring element 7 is provided which applies pressure to the rotatable mounting in such a way that the clamping effect is supported.

In order to feed the cable 9 from the storage facility 14 of the lift car 5, the clamping effect of the cable holder 22 must be temporarily released or reduced. For this purpose, the pulley fixture 23 is loaded in the direction of rotation opposite to the direction of rotation in which the pulley fixture 23 is loaded due to the weight of the section of cable and the tension of the spring. This counter-loading can, in particular, be applied by means of a crane or a lifting device (e.g. cable winch) attached to the lift car 5 which engages with a connecting bolt 26 of the pulley fixture 23.

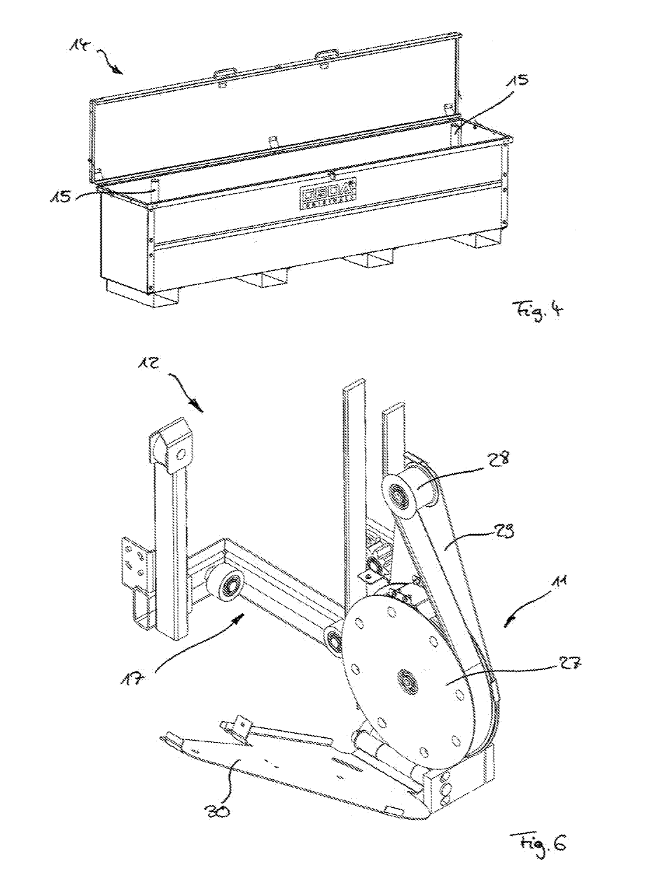

The cable trolley 12 of the lift is so designed that it is possible to introduce the cable 9 from the side (in relation to the pulley fixture 11). The pulley fixture 11 of the cable trolley 12 comprises a deflecting pulley 27 as well as a guide pulley 28, which are both partially wound around by the cable 9. In order to make it possible to introduce the cable 9 into the cable trolley 12 from the side, the deflecting pulley 27 and the guide pulley 28 are mounted rotatably on one side on a first side component 29 of the pulley fixture 11. A second side component 30 is integrated in the cable trolley 12 so as to swivel and when opened (see FIG. 6) makes it possible to introduce the cable from the side. In contrast, when in its closed state, in which this second side component 30 is arranged in close proximity next to the deflecting pulley 27 and the guide pulley 28, this prevents the cable 9 from becoming detached from the deflecting pulley 27 and the guide pulley 28.

During erection of the lift it can be necessary to change the position of the central infeed 13 on the cable 9. A hoisting device 31 can thereby be used which is shown in detail in FIG. 9. The hoisting device 31 comprises a clamping device with a clamping plate 32, mounted so as to be axially movable, within limits, in a guideway of a base plate 33 of the clamping device. The guideway is thereby aligned at an inclination to the base plate. The effect of this is that a downwards movement of the clamping plate 32 relative to the base plate 33, i.e. in the direction of the ground station 1, leads to a reduction in the gap formed between these, in which the cable 9 runs. This causes the cable 9 to be clamped. The clamping effect of the clamping device is thereby self-reinforcing, in that the weight of the section of cable pulls the cable 9 located below the hoisting device 31 downwards and thereby, as a result of the friction acting between the cable 9 and the clamping plate 32, pulls the clamping plate 32 downwards. The friction between the cable 9 and the clamping plate 32 and thus the clamping effect thereby increases with the increasing weight of the cable.

If the position of the central infeed 13 on the cable 9 is to be changed, the hoisting device 31 is brought into use. This can be used to secure or change the position of the section of cable while the clamping device of the central infeed 13 is released. For this purpose, the hoisting device 31 can be fixed to the guideway 3 and the central infeed 13 moved relative to the cable 9. However, it is also possible to leave the central infeed 13 fixed to the guideway 3 without moving it and raise or lower the cable 9 by means of the hoisting device 31. This can for example be done by means of a crane, the hook of which engages in a lug 34 on the base plate 33.

The lift also features a plurality of cable guides 36, which can be fixed to the guideway 3 at different heights. The cable guides 36 serve to guide the individual sections of cable arranged between the cable holder 22 and the ground station 1. This is intended to limit any swinging of these sections of cable as a result of wind and the movement of the lift car 5. The cable guides 36 comprise a supporting structure 37, which forms two times three guide regions which are structurally separate from one another. A first guide region 38 serves to guide the section of cable running from the central infeed 13 to the ground station 1. This first guide region 38 is separated from a second guide region 39 which serves to guide the section of cable running from the central infeed 13 to the cable trolley 12 by a cross-strut of the supporting structure 37. The second guide region 39 is separated from a third guide region 41 which serves to guide the section of cable running the cable trolley 12 to the cable holder 22 by elastic webs 40 (made of elastomer).

Depending on the position of the relevant cable guide 36 on the guideway 3 as well as the position of the cable trolley 12, the cable is not guided in all guide regions 38, 39, 41 of the individual cable guides 36.

Lateral openings in the first guide regions 38 are also closed by means of elastic webs 40. The corresponding section of cable can be introduced from the side without significant effort through a deformation of these webs 40. This means that the cable guides 36 can, without any problem, be fitted to the guideway 3 in succession during the erection of the lift.

The front openings of the third guide regions 41 are also closed by means of elastic webs 40. These webs, as well as the webs 40 arranged between the second guide region 39 and the third guide region 41 ensure that the relevant section of cable remains in the intended guide region 39, 41, while at the same time the pulley fixture 11 of the cable trolley 12 can pass through this, whereby the webs 40 are elastically deformed.

The cable 9 comprises several cable strands within a protective sheath for the transmission of the electrical supply energy as well as several control lines for the transmission of control signals. In order to protect these cable strands and control lines, these can be provided with collective or individual strain-relief measures, e.g. in the form of aramid braided sleeving. This embodiment in combination with the design as a flat cable makes it possible for the cable 9 to have comparatively small bending radii.

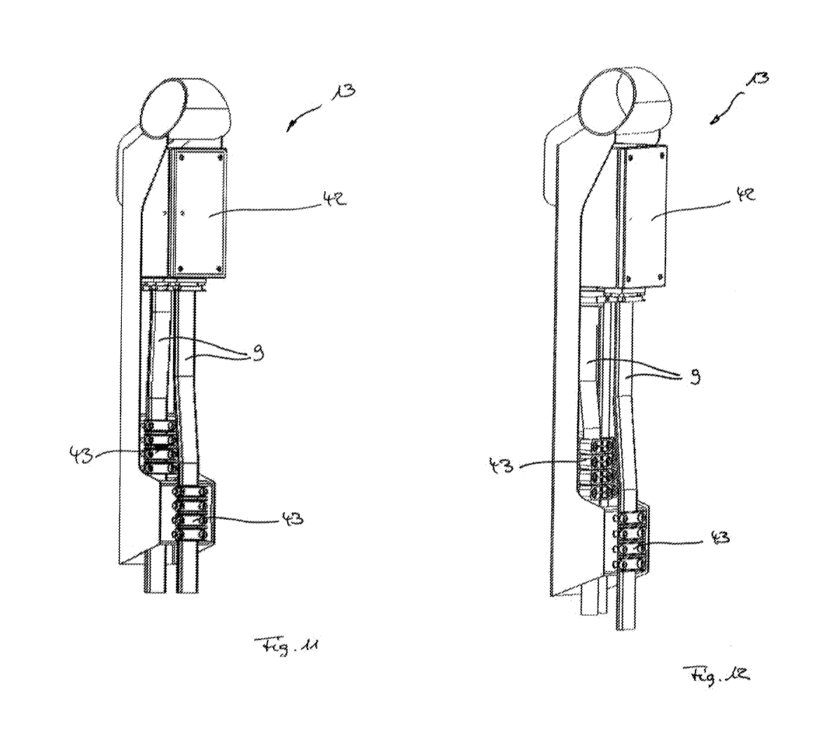

Alternative embodiments of the central infeed 13 are illustrated in FIGS. 11 and 12. These differ from the central infeed 13 shown in FIG. 5, on the one hand, in that they [serve to] connect two separate sections of cable, the section of cable running to the ground station and the section of cable running via the cable trolley 12. For this purpose, these central infeeds possess a connecting device 42 which can, for example, comprise two plug connectors into which the ends of the sections of cable, fitted with corresponding mating connectors, can be plugged. The cable strands and control lines contained in the sections of cable can thus be electrically connected within the connecting device.

The central infeeds 13 illustrated in FIGS. 11 and 12 also differ from the central infeed 13 described previously in the method of fixing the sections of cable, which takes place here by means of clamping plates 43 fixed in place by screws. Insofar as, as illustrated, the cable 9 is divided into in two separate sections of cable, a clamping plate 43 is provided for each section of cable.

The central infeed 13 illustrated in FIG. 12 differs in terms of the type of cable used for the section of cable running to the ground station. This is designed in the form of a round cable, whereas a flat cable, as used for both sections of cable in the embodiment shown in FIG. 11, is used for the section of cable running via the cable trolley 12.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A lift comprising a guideway, a ground station, a lift car guided on the guideway, a cable running along the guideway to the lift car, which is passed via a cable trolley with a pulley fixture which follows a movement of the lift car, and a central infeed into which the cable can be fixed and which can be fixed to the guideway, wherein a storage facility for storage of a section of cable is provided both at the ground station and on the lift car.

2. The lift of claim 1, wherein the storage facility at the ground stationor on the lift car, or both, stores the relevant section of cable in figures of eight or in coils.

3. The lift of 2, wherein the storage facility at the ground station or on the lift car, or both, stores the relevant section of cable in offset figures of eight.

4. The lift of claim 1, wherein the storage facility is arranged on the roof of the lift car.

5. The lift of claim 1, wherein the central infeed includes fixing means for receiving a lifting element.

6. The lift of claim 1 including a cable holder arranged on the lift car into which the cable can be fixed.

7. The lift of claim 6, wherein the cable is fixed in the cable holder by a clamping device which is self-reinforcing in interaction with the weight of the section of cable running via the cable trolley.

8. The lift of claim 6, wherein the cable is fixed in the cable holder by a spring-loaded clamping device.

9. The lift of claim 1, including a hoisting device into which the cable is fixed and which is movable along the guideway.

10. The lift of claim 9, wherein the cable is fixed in the hoisting device by a clamping device which is self-reinforcing in interaction with the weight of the section of cable running along the guideway.

11. The lift of claim 1, wherein the cable is introduced laterally into the cable trolley.

12. The lift of claim 11, wherein the cable trolley includes a pulley element which is arranged between two side components, one of said side components being removable from the pulley element in order to permit lateral introduction of the cable.

13. The lift of claim 1, including a cable guide fixed to the guideway below the central infeed in which the cable is guided.

14. The lift of claim 13, wherein the cable guide includes a guide region for the section of cable extending between the ground station and the central infeed as well as one or two separate guide regions for the section of cable passed via the cable trolley.

15. A method for erecting a lift according to claim 1, wherein the guideway extends to a total length through the addition of individual guideway segments, wherein the central infeed is fixed to the guideway at different heights, following the extension of the guideway, such that an extension of the section of cable running between the central infeed and the ground station which is necessary in order to raise the central infeed is supplied from the storage facility at the ground station and an extension of the section of cable running via the cable trolley which is necessary due to the extension of the guideway is supplied from the storage facility of the lift car.

16. The lift of claim 3, wherein the storage facility is arranged on the roof of the lift car.

17. The lift of claim 1, wherein the central infeed includes a fastener for receiving a lifting element.

18. The lift of claim 3 including a cable holder arranged on the lift car into which the cable can be fixed.

19. The lift of claim 7, wherein the cable is fixed in the cable holder by a spring-loaded clamping device.

20. The lift of claim 8, including a hoisting device into which the cable is fixed and which is movable along the guideway.

21. The lift of claim 20, including a cable guide fixed to the guideway below the central infeed in which the cable is guided.

22. The lift of claim 21, wherein the cable guide includes a guide region for the section of cable extending between the ground station and the central infeed as well as one or two separate guide regions for the section of cable passed via the cable trolley.
